(19) United States
(12) Patent Application Publication
(10) Pub. No.: US 2018/0036837 A1
(43) Pub. Date: Feb. 8, 2018

(54) WELDING DEVICE, WELDING METHOD, AND TURBINE BLADE

(71) Applicant: MITSUBISHI HITACHI POWER SYSTEMS, LTD., Yokohama-shi, Kanagawa (JP)

(72) Inventors: Naonori NAGAI, Tokyo (JP); Takehisa OKUDA, Tokyo (JP); Satoshi SOMETANI, Tokyo (JP); Yasuo MATSUNAMI, Tokyo (JP)

(73) Assignee: Mitsubishi Hitachi Power Systems, Ltd., Yokohama-shi, Kanagawa (JP)

(21) Appl. No.: 15/551,532

(22) PCT Filed: Feb. 19, 2015
(86) PCT No.: PCT/JP2015/054585

§ 371 Date: Aug. 16, 2017

(51) Int. Cl. B23K 26/144; B05B 7/22; B23K 26/14; B23K 26/342; F01D 5/28

(52) U.S. Cl. CPC B23K 26/144; B23K 26/342; F01D 5/288; B23K 26/1464; B05B 7/228; B23K 26/147; B23K 2201/001

(57) ABSTRACT

A welding device including a cylindrical powder nozzle (201) that supplies a powder gas containing a powder welding material toward a laser beam irradiation position of a base material and a cylindrical shield nozzle (202) that is arranged coaxially so as to cover an outer peripheral surface of the powder nozzle (201) and supplies a shielding gas for isolating the laser beam irradiation position, in which an outer peripheral surface (201b) in the vicinity of a distal end portion (201a) of the powder nozzle (201) has a shape whose outer diameter gradually decreases toward a distal end portion (201a) of the powder nozzle (201) and has an arc-shaped section on a section passing through a center axis (A) of the powder nozzle (201) is provided.

### TECHNICAL FIELD

The present invention relates to a welding device, a welding method, and a turbine blade.

### BACKGROUND ART

There is a concern that a steam turbine blade is eroded by an impact action applied by fine solid particles mainly composed of condensed water droplets or iron oxide in a steam, and its surface is worn. By forming an erosion-resistant layer (anti-erosion layer) on a front edge portion which is on a front (upstream side of a steam flow) of the steam turbine blade, the erosion of the steam turbine blade is suppressed.

Patent Literature 1 discloses formation of the erosion-resistant layer by joining an erosion shield on which a boronized layer is formed on a surface to a substrate of the steam turbine blade. Patent Literature 2 discloses formation of the erosion-resistant layer by cutting out a blade leading edge portion which is a part of a blade shape of the turbine rotation blade and by using cladding by welding with a laser.

### CITATION LIST

### {Patent Literature}

### {PTL 1}

Japanese Examined Patent Application, Publication No. Sho 61-12082

### {PTL 2}

the Publication of Japanese Patent No. 4901413

### SUMMARY OF INVENTION

### {Technical Problem}

As an erosion-resistant layer joined to the substrate of the steam turbine blade, a material with high abrasion resistance such as Stellite® containing cobalt as a main component, for example, is used. As a method of joining a material such as a cobalt-base alloy to the substrate, brazing or cladding by welding by TIG (Tungsten Inert Gas) welding is used. However, in the case of joining using brazing, there is a problem that nonconformity such as defective joining can easily occur, and deformation of the steam turbine blade caused by heating over a wide range can also occur easily. In the case of joining by the TIG welding, the welding material such as the cobalt-base alloy is diluted by a base material, which leads to a problem that hardness of the erosion-resistant layer is lowered.

When a method of performing clad welding by blowing a gas containing a powder welding material (hereinafter referred to as a powder gas) to an irradiation position of the laser is used, the nonconformities of the brazing or the TIG welding can be suppressed. In this clad welding using the laser, when a welded part reacts with oxygen at the laser beam irradiation position of a welding target, sputtering occurs. In order to prevent occurrence of sputtering by shutting out entry of oxygen into the welded part, use of an argon gas or a helium gas as a shielding gas is known.

However, when a large-scale eddy structure occurs in the shielding gas, oxygen contained in an ambient air is led to the welded part, and sputtering occurs, which degrades a welding quality.

The eddy structure, here, includes both a lateral eddy having an eddy axis orthogonal to a flow direction of the shielding gas and a vertical eddy having an eddy axis in parallel with the flow direction of the shielding gas. The lateral eddy is caused by friction or separation between the shielding gas and a wall surface of a shield nozzle through which the shielding gas flows, while the vertical eddy is caused by a jet flow of the shielding gas.

The present invention was made in view of the aforementioned circumstances and has an object to provide a welding device, a welding method, and a turbine blade welded by the welding method which can suppress occurrence of a large-scale eddy structure in a shielding gas and capable of high-quality cladding by welding using laser.

### {Solution to Problem}

The present invention employed the following means in order to solve the aforementioned problems.

A welding device according to a first aspect of the present invention includes a cylindrical powder nozzle that supplies a powder gas containing a powder welding material to a laser beam irradiation position of a welding target and a cylindrical shield nozzle that is arranged coaxially so as to cover an outer peripheral surface of the powder nozzle and supplies a shielding gas for isolating the laser beam irradiation position, in which the outer peripheral surface in the vicinity of a distal end portion of the powder nozzle has a shape whose outer diameter gradually decreases toward the distal end portion of the powder nozzle and has an arc shape on a section passing through a center axis of the powder nozzle.

The welding device according to the first aspect of the present invention performs clad welding by supplying the powder gas containing the powder welding material from the cylindrical powder nozzle to the laser beam irradiation position of the welding target. To the laser beam irradiation position, the shielding gas is supplied from the cylindrical shield nozzle arranged coaxially so as to cover the outer peripheral surface of the powder nozzle, and the laser beam irradiation position is isolated. The outer peripheral surface in the vicinity of the distal end portion of the powder nozzle has an arc shape whose outer diameter gradually decreases toward the distal end portion of the powder nozzle.

Since the distal end portion of the powder nozzle has an arc shape, separation of the shielding gas flowing out of the shield nozzle along the outer peripheral surface of the powder nozzle is suppressed, and the lateral eddy having the eddy axis orthogonal to the flow direction of the shielding gas cannot occur easily. Moreover, since vorticity generation is suppressed by suppression of the lateral eddy, occurrence of the vertical eddy caused by tilting of the eddy axis of the lateral eddy in the jet flow of the shielding gas is also suppressed. By suppressing occurrence of the large-scale eddy structure in the shielding gas, entry of atmospheric air (oxygen) in the periphery into the welded part caused by occurrence of the eddy structure is prevented.

Therefore, occurrence of the large-scale eddy structure in the shielding gas can be suppressed, and high-quality clad welding using the laser can be performed.

In the welding device of the first aspect of the present invention, an inner peripheral surface in the vicinity of the distal end portion of the powder nozzle has a shape whose inner diameter gradually increases toward the distal end portion of the powder nozzle, and it may be so constituted that a sectional shape on a section passing through a center axis of the powder nozzle is an arc shape. In this constitution, since the distal end portion of the powder nozzle has an arc shape, the lateral eddy having the eddy axis orthogonal to the flow direction of the powder gas cannot occur easily in the powder gas flowing out of the powder nozzle along the inner peripheral surface of the powder nozzle. Moreover, since the vorticity generation is suppressed by suppression of the lateral eddy, occurrence of the vertical eddy caused by tilting of the eddy axis of the lateral eddy in the jet flow of the powder gas can be also suppressed. As a result, such nonconformity is prevented that the eddy structure occurs in the powder gas, which causes occurrence of the eddy structure in the shielding gas.

A welding device of a second aspect of the present invention includes a cylindrical powder nozzle that supplies a powder gas containing a powder welding material to a laser beam irradiation position of a welding target and a cylindrical shield nozzle that is arranged coaxially so as to cover an outer peripheral surface of the powder nozzle and supplies a shielding gas for isolating the laser beam irradiation position, and an eddy suppressing member that suppresses occurrence of an eddy by the shielding gas is provided on an inner peripheral surface in the vicinity of a distal end portion of the shield nozzle.

The welding device according to the second aspect of the present invention performs clad welding by supplying the powder gas containing the powder welding material from the cylindrical powder nozzle to the laser beam irradiation position of the welding target. To the laser beam irradiation position, the shielding gas is supplied from the cylindrical shield nozzle arranged coaxially so as to cover the outer peripheral surface of the powder nozzle, and the laser beam irradiation position is isolated. In the shielding gas supplied from the shield nozzle to the laser beam irradiation position, occurrence of an eddy by the shielding gas is suppressed by the eddy suppressing member provided on the inner peripheral surface in the vicinity of the distal end portion of the shield nozzle.

Since the eddy suppressing member is provided on the inner peripheral surface in the vicinity of the distal end portion of the shield nozzle, the lateral eddy having the eddy axis orthogonal to the flow direction of the shielding gas cannot occur easily in the shielding gas flowing out of the shield nozzle. Moreover, occurrence of the vertical eddy caused by tilting of the eddy axis of the lateral eddy in the jet flow of the shielding gas is also suppressed. By suppressing occurrence of the large-scale eddy structure by the shielding gas, entry of the atmospheric air (oxygen) in the periphery into the welded part by occurrence of the eddy structure is prevented.

Therefore, occurrence of the large-scale eddy structure in the shielding gas is suppressed, and high-quality clad welding using the laser can be performed.

In the welding device of the second aspect of the present invention, the eddy suppressing member may be so constituted to include a plurality of projecting portions protruding toward the center axis of the shield nozzle. In this constitution, the eddy which occurs in the shielding gas passing near the plurality of projecting portions is crushed by the plurality of projecting portions, whereby growth of the eddy is suppressed.

A welding method according to the present invention includes a welding process of supplying a powder gas containing a powder welding material to a joining portion between a substrate of a turbine blade front edge portion and an erosion-resistant metal material by using the welding device of any one of the aspects according to the present invention and of clad welding the substrate and the erosion-resistant metal material.

By performing as above, occurrence of the large-scale eddy structure in the shielding gas is suppressed, and a welding method of performing high-quality clad welding using the laser can be provided.

A turbine blade according to the present invention, wherein the erosion-resistant metal material is clad welded by the welding method according to the present invention.

By performing as above, occurrence of the large-scale eddy structure in the shielding gas is suppressed, and a turbine blade on which high-quality clad welding using the laser is performed can be provided.

### {Advantageous Effects of Invention}

According to the present invention, the welding device, the welding method, and the turbine blade welded by the welding method which suppresses occurrence of the large-scale eddy structure in the shielding gas and can perform high-quality clad welding using the laser can be provided.

### BRIEF DESCRIPTION OF DRAWINGS

FIG. 1 is an outline configuration diagram illustrating a welding device of an embodiment of the present invention.

FIG. 2 is a sectional view on a section passing through a center axis of a nozzle part of a first embodiment.

FIG. 3 is a view seen along the center axis of the nozzle part of the first embodiment.

FIG. 4 is a sectional view on a section passing through a center axis of a nozzle part of a second embodiment.

FIG. 5 is a sectional view on a section passing through a center axis of a nozzle part of a third embodiment.

FIG. 6 is a sectional view on a section passing through a center axis of a nozzle part of a comparative example.

FIG. 7 is a view illustrating a steam turbine blade.

### DESCRIPTION OF EMBODIMENTS

### First Embodiment

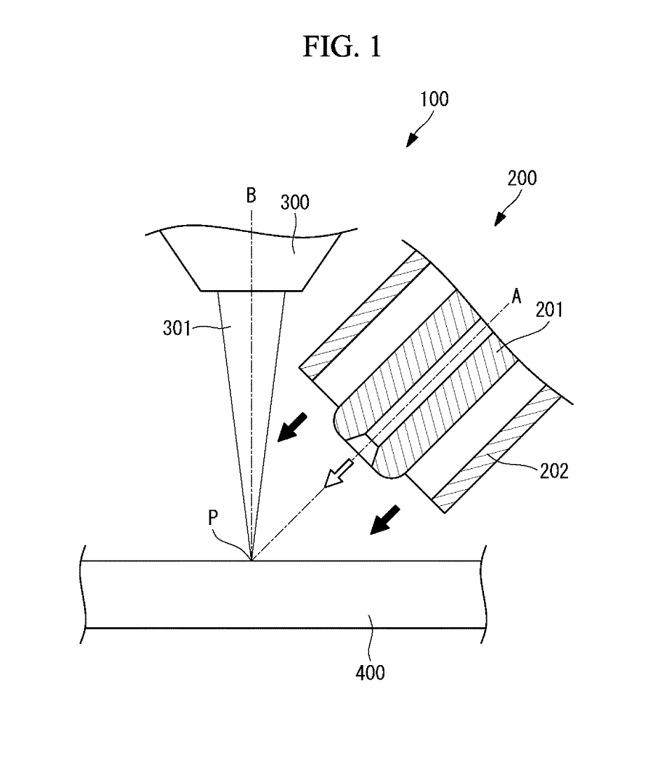

Hereinafter, a welding device 100 of a first embodiment of the present invention will be explained by referring to FIG. 1.

FIG. 1 is an outline configuration diagram illustrating the welding device 100 of this embodiment.

The welding device 100 is a device that performs clad welding by projecting a laser to a base material 400 which is a welding target and by supplying a welding material to a laser beam irradiation position P on the base material 400. Here, the welding material contains an erosion-resistant metal material such as Stellite®.

The welding device 100 includes a laser part 300 that projects a laser beam 301 to the base material 400 and a nozzle part 200 that supplies a powder gas containing a powder welding material to the laser beam irradiation position P. The nozzle part 200 has a double-tube structure of a cylindrical powder nozzle 201 and a shield nozzle 202 arranged around a center axis A. The shield nozzle 202 is arranged coaxially with the center axis A so as to cover an outer peripheral surface of the powder nozzle 201. The powder gas is supplied from the powder nozzle 201 to the laser beam irradiation position P, and the shielding gas is supplied so as to cover an outer side of the powder gas and to isolate the laser beam irradiation position from an atmospheric air (oxygen). As the shielding gas, an argon gas or a helium gas is suitably used. As the powder gas, a powder welding material mixed with an argon gas or a helium gas is preferably used.

An extension of the center axis A of the nozzle part 200 and an extension of a laser beam axis B of the laser part 300 cross each other on a surface of the base material 400, and its position is the laser beam irradiation position P.

The welding device 100 performs clad welding at the laser beam irradiation position P by supplying the powder gas containing the powder welding material to the laser beam irradiation position P irradiated with the laser beam 301.

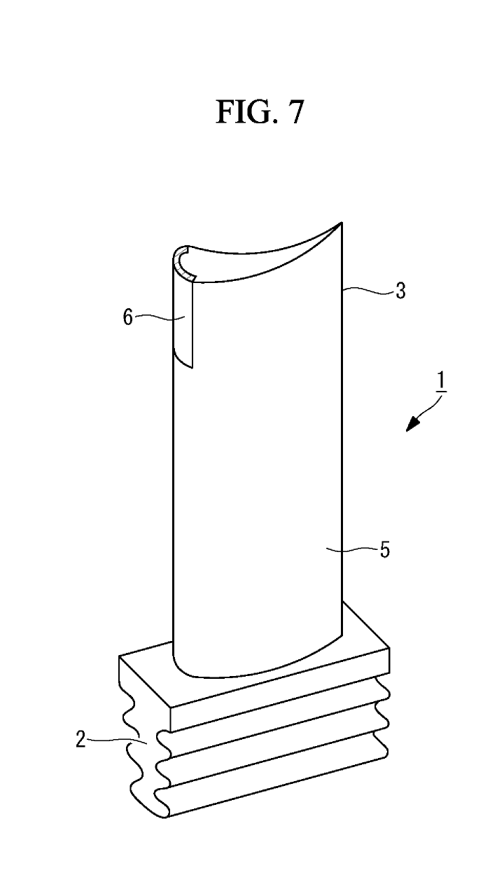

As the base material 400 which is the welding target, various substances can be used. As the base material 400, a steam turbine blade 1 can be used as a target, for example. The steam turbine blade 1 is used in a steam turbine, and as illustrated in FIG. 7, it includes a root part 2 and a blade-shaped part 3. The root part 2 is mounted on a rotor of the steam turbine. The blade-shaped part 3 is formed having a blade shape and is fixed to the root part 2. The blade-shaped part 3 is exposed to a steam flowing through the steam turbine when the root part 2 is mounted on the rotor of the steam turbine.

The blade-shaped part 3 includes a body portion 5 and a protection portion 6. The body portion 5 is formed having a roughly blade shape and is formed integrally with the root part 2 and is fixed to the root part 2. The protection portion 6 is a thin plate-shaped member formed of Stellite®. The protection portion 6 is joined to the body portion 5 so as to form a front edge portion of a blade end of the blade-shaped part 3.

The welding device 100 of this embodiment can be used as a device for welding a joining portion when the protection portion 6 and the body portion 5 are joined to each other. Since the powder gas used for laser clad welding contains the erosion-resistant metal material, the problem that hardness of the erosion-resistant layer lowers can be avoided as compared with the case of joining the protection portion 6 and the body portion 5 by brazing or TIG welding.

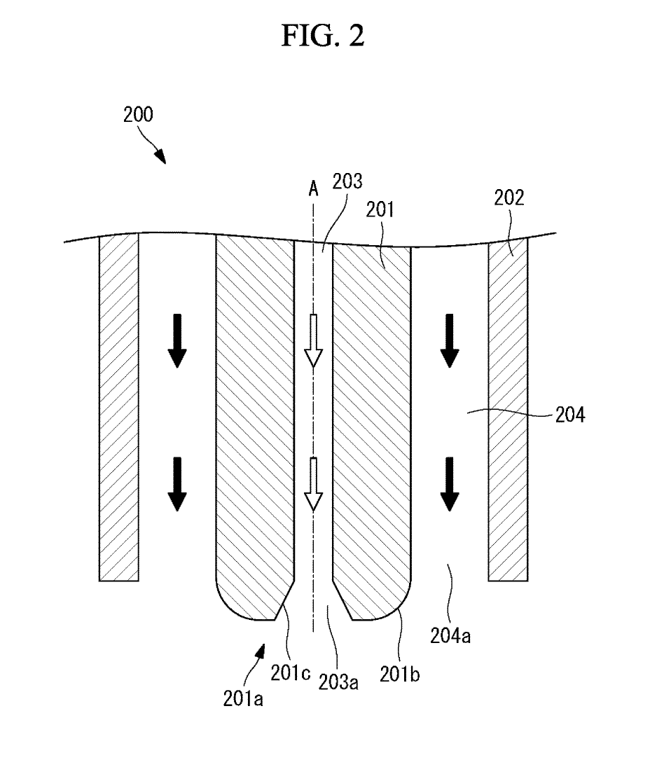

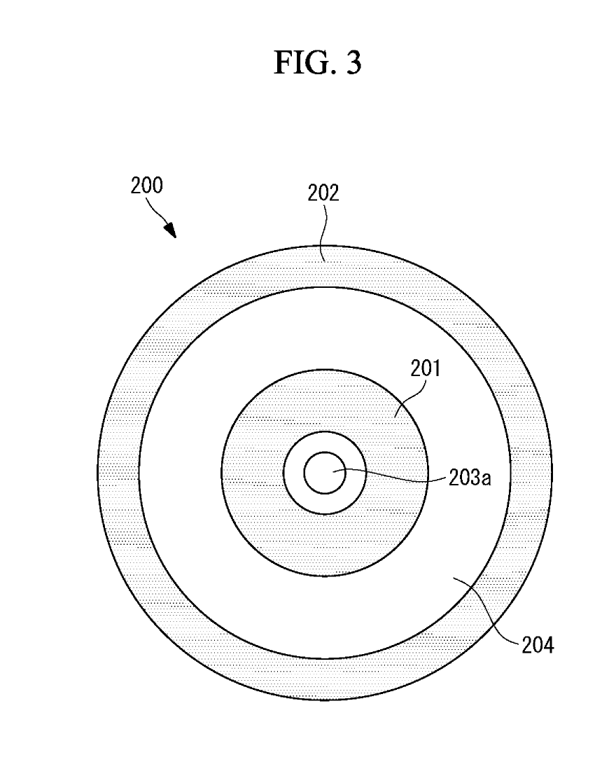

Subsequently, constitution of the nozzle part 200 will be explained in more detail by using FIGS. 2 and 3. FIG. 2 is a sectional view on a section passing through the center axis A of the nozzle part 200 in the first embodiment. FIG. 3 is a view when seen along the center axis of the nozzle part of the first embodiment. As described above, the nozzle part 200 has a double-tube structure of the cylindrical powder nozzle 201 and the shield nozzle 202 arranged around the center axis A.

An inner peripheral side of the powder nozzle 201 is a circular powder gas channel 203 on a sectional view. The powder gas channel 203 communicates with a powder gas supply source (not shown) and allows the powder gas supplied from the powder gas supply source to flow along an arrow direction in FIG. 2.

An end portion of the powder gas channel 203 is a powder gas outlet 203a opened to an outside. The powder gas flowing out of the powder gas outlet 203a is supplied to the laser beam irradiation position P. On the inner peripheral surface in the vicinity of a distal end portion 201a of the powder nozzle 201 forming the powder gas outlet 203a, a taper portion 201c is provided. The taper portion 201c has a shape whose inner diameter increases at a certain gradient toward the distal end portion 201a of the powder nozzle 201.

The gradient of the taper portion 201c regulates a diffusion range (application range of thermal spraying) of the powder gas flowing out of the powder nozzle 201 from the center axis A. By setting this gradient of the taper portion 201c and a distance from the nozzle part 200 to the laser beam irradiation position appropriately, welding in an appropriate range can be performed.

A space partitioned by the outer peripheral surface of the powder nozzle 201 and the inner peripheral surface of the shield nozzle 202 and having an annular section in a direction orthogonal to the center axis A is a shielding gas channel 204. The shielding gas channel 204 communicates with a shielding gas supply source (not shown) and allows the shielding gas supplied from the shielding gas supply source to flow along the arrow direction in FIG. 2.

An end portion of the shielding gas channel 204 is a shielding gas outlet 204a opened to the outside. The shielding gas flowing out of the shielding gas outlet 204a is supplied to the annular region around the laser beam irradiation position P so as to isolate the laser beam irradiation position P.

In the vicinity of the distal end portion 201a of the powder nozzle 201, an outer peripheral surface 201b having a shape whose outer diameter gradually decreases toward the distal end portion 201a of the powder nozzle 201 is provided. As illustrated in FIG. 2, the outer peripheral surface 201b has an arc-shaped section on the section passing through the center axis A of the powder nozzle 201.

The powder gas flowing out of the powder nozzle 201 and the shielding gas flowing out of the shield nozzle 202 merge after they flow out of the powder gas channel 203 and the shielding gas channel 204, respectively. The shielding gas is a gas for isolating the laser beam irradiation position P (welded part) from the atmospheric air containing oxygen. The powder gas and the shielding gas preferably flow in the respective layers so as not to be mixed together.

Thus, in the welding device 100 of this embodiment, a flow velocity of the powder gas and a flow velocity of the shielding gas are adjusted so as to become a substantially equal velocity. By adjusting the flow velocity of the powder gas and the flow velocity of the shielding gas to become substantially equal, nonconformity of mixing of the powder gas and the shielding gas can be suppressed. This adjustment of the flow velocities is made by appropriately setting various parameters such as a flow rate of the powder gas, a channel width of the powder gas channel 203, a flow rate of the shielding gas, and a channel width of the shielding gas channel 204.

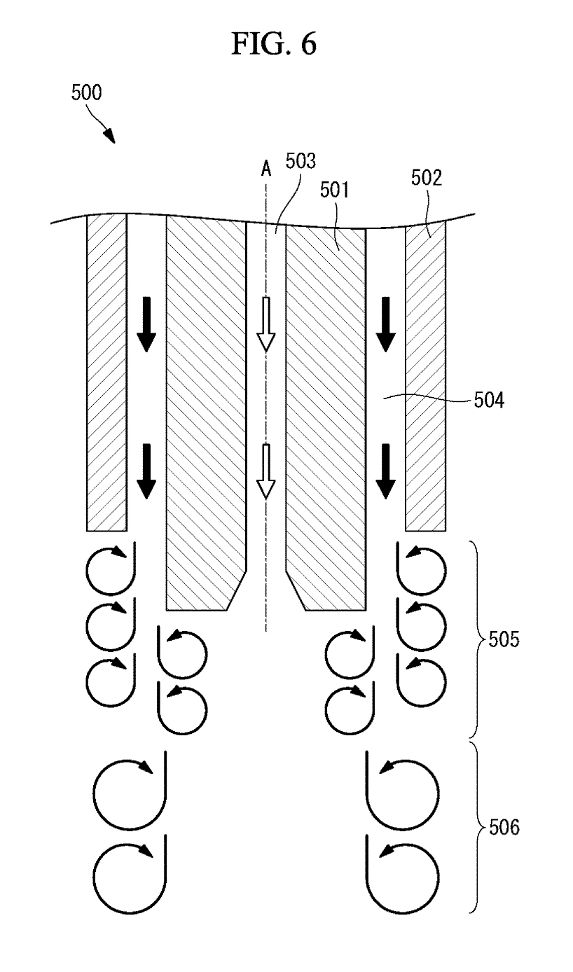

Here, a comparative example of this embodiment will be explained by using FIG. 6. FIG. 6 is a sectional view on a section passing through a center axis A of a nozzle part 500 of the comparative example. The nozzle part 500 in the comparative example includes a powder nozzle 501 and a shield nozzle 502. In the powder nozzle 501, a powder gas channel 503 is provided, and a space partitioned by an inner peripheral surface of the shield nozzle 502 and an outer peripheral surface of the powder nozzle 501 is a shielding gas channel 504.

When the nozzle part 200 in this embodiment illustrated in FIG. 2 is compared with the nozzle part 500 in the comparative example illustrated in FIG. 6, the outer peripheral surface 201b having an arc-shaped section is provided on the distal end portion 201a of the nozzle part 200, while the outer peripheral surface in parallel with the center axis A is provided in the vicinity of the distal end portion of the nozzle part 500, which is a difference. Moreover, as compared with a position of the distal end portion of the shield nozzle 202 in the first embodiment illustrated in FIG. 2, a position of the distal end portion of the shield nozzle 502 in the comparative example illustrated in FIG. 6 is retreated along the flow direction of the shielding gas.

At the distal end portion of the nozzle part 500 in FIG. 6, an arrow schematically indicating an eddy structure occurring in the shielding gas flowing out of the shielding gas channel is illustrated. This eddy structure includes both a lateral eddy having an eddy axis orthogonal to the flow direction of the shielding gas and a vertical eddy having an eddy axis in parallel with the flow direction of the shielding gas. In the vicinity of the distal end portion of the powder nozzle 501 in the comparative example, the outer peripheral surface in parallel with the center axis A is provided. Thus, the shielding gas having passed through the distal end portion of the nozzle part 500 is rapidly diffused in the direction orthogonal to the center axis A. Thus, the flow of the shielding gas is disturbed, and an eddy structure 505 is generated in the shielding gas.

Moreover, the position of the distal end portion of the shield nozzle 502 in the comparative example is retreated along the flow direction of the shielding gas. Thus, at the position having passed through the distal end portion of the shield nozzle 502, the outer peripheral surface of the powder nozzle 501 is present on a side closer to the center axis A, while the shield nozzle 502 is not present on a side far from the center axis A. Thus, the shielding gas is rapidly diffused in the direction away from the center axis A after having passed through the distal end portion of the shield nozzle 502. Thus, the flow of the shielding gas is disturbed, and the eddy structure 505 is generated in the shielding gas.

Moreover, the eddy structures 505 generated in a large quantity move along the flow direction of the shielding gas and overlap with the other plural eddy structures 505. As a result, a much larger eddy structure 506 is generated. Such large eddy structure 506 acts so as to lead the atmospheric air (oxygen) present on an outer peripheral side of the eddy structure 506 with respect to the center axis A to an inner side of the eddy structure 506 with respect to the center axis A. Thus, the oxygen flows into the laser beam irradiation position P where the laser clad welding is performed and is led to the welded part so as to cause sputtering, whereby the welding quality is degraded. In this embodiment, occurrences of the eddy structures 505 and 506 are suppressed and thus, degradation of the welding quality is prevented.

Here, the welding method using the welding device 100 of this embodiment will be explained.

This welding method is a method of executing a welding process in which the powder gas containing the powder welding material is supplied to the joining portion between the body portion 5 of the turbine blade front edge portion and the protection portion 6 of the erosion-resistant metal material, and the body portion 5 and the protection portion 6 of the erosion-resistant metal material are clad welded by using the welding device 100.

According to such welding method, occurrence of the large-scale eddy structure in the shielding gas is suppressed, and the high-quality clad welding can be performed by using the laser.

As described above, the welding device 100 of this embodiment performs clad welding by supplying the powder gas containing the powder welding material from the cylindrical powder nozzle 201 to the laser beam irradiation position P of the base material 400 which is the welding target. To the laser beam irradiation position P, the shielding gas is supplied from the cylindrical shield nozzle 202 arranged coaxially so as to cover the outer peripheral surface of the powder nozzle 201, and the laser beam irradiation position P is isolated. The outer peripheral surface 201b in the vicinity of the distal end portion 201a of the powder nozzle has an arc shape whose outer diameter gradually decreases toward the distal end portion 201a of the powder nozzle 201.

Since the distal end portion 201a of the powder nozzle 201 is the outer peripheral surface 201b having an arc shape, a lateral eddy having the eddy axis orthogonal to the flow direction of the shielding gas cannot occur easily in the shielding gas flowing out of the shielding gas channel 204 along the outer peripheral surface 201b of the powder nozzle 201. Moreover, occurrence of a vertical eddy caused by tilting of the eddy axis of the lateral eddy in the jet flow of the shielding gas is also suppressed. By suppressing occurrence of the large-scale eddy structure in the shielding gas, entry of the atmospheric air (oxygen) in the periphery into the welded part at the laser beam irradiation position P by occurrence of the eddy structure is prevented.

Therefore, occurrence of the large-scale eddy structure in the shielding gas is suppressed, and the high-quality clad welding by using the laser can be performed.

### Second Embodiment

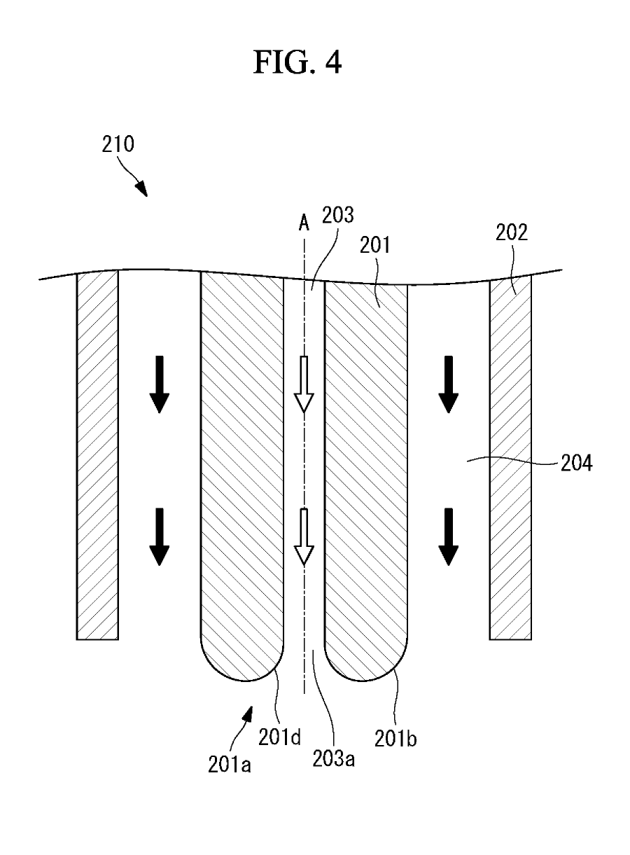

A welding device of a second embodiment of the present invention will be explained below by referring to FIG. 4.

FIG. 4 is a sectional view on a section passing through a center axis A of a nozzle part 210 of the second embodiment.

The second embodiment is a modification of the first embodiment and is assumed to be similar to the first embodiment except a case particularly described below and the explanation will be omitted below. The nozzle part 200 of the first embodiment includes the taper portion 201c, while the nozzle part 210 of the second embodiment includes an inner peripheral surface 201d having an arc-shaped section, which is a difference.

In the nozzle part 210 of the welding device of the second embodiment, the inner peripheral surface 201d in the vicinity of the distal end portion 201a of the powder nozzle 201 has a shape whose inner diameter gradually increases toward the distal end portion 201a of the powder nozzle 201. Moreover, as illustrated in FIG. 4, the inner peripheral surface 201d has an arc-shaped section on a section passing through the center axis A of the powder nozzle 201.

In the nozzle part 210 of the second embodiment, since the inner peripheral surface 201d of the distal end portion 201a of the powder nozzle 201 has the arc shape, a lateral eddy having an eddy axis orthogonal to the flow direction of the powder gas cannot occur easily in the powder gas flowing out of the powder nozzle 201 along the inner peripheral surface 201d of the powder nozzle 201. Moreover, occurrence of a vertical eddy caused by tilting of the eddy axis of the lateral eddy in the jet flow of the powder gas is also suppressed. As a result, such nonconformity that the eddy structure is generated in the powder gas, whereby an eddy structure is generated in the shielding gas is prevented.

### Third Embodiment

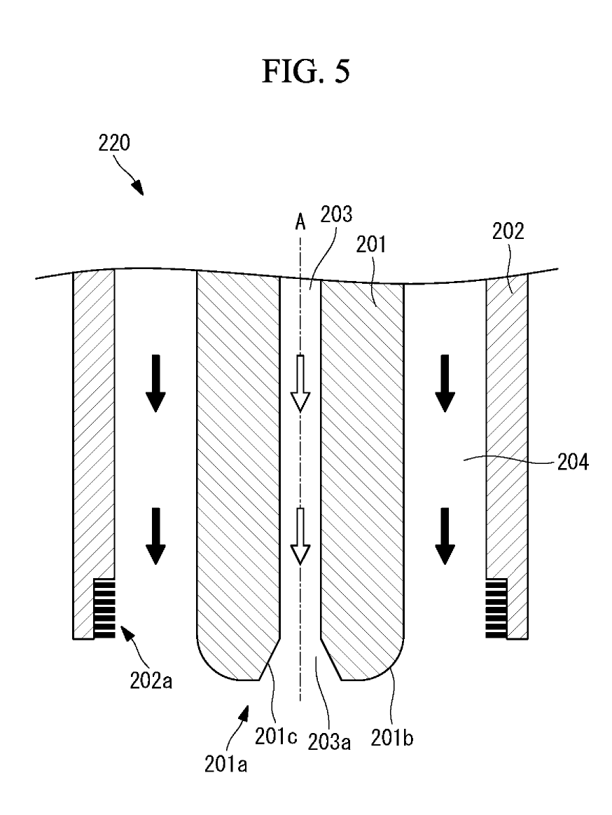

A welding device of a third embodiment of the present invention will be explained below by referring to FIG. 5.

FIG. 5 is a sectional view on a section passing through a center axis A of a nozzle part 220 of the third embodiment.

The third embodiment is a modification of the first embodiment and is assumed to be similar to the first embodiment except a case particularly described below and the explanation will be omitted below. The nozzle part 200 of the first embodiment has a flat inner peripheral surface of the distal end portion of the shield nozzle 202, while the nozzle part 220 of the third embodiment has an eddy suppressing member 202a provided on the inner peripheral surface of the distal end portion of the shield nozzle 202, which is a difference.

The eddy suppressing member 202a is preferably provided on the distal end portion of the shield nozzle 202, but it may be provided at another position as long as it is in the vicinity of the distal end portion.

The nozzle part 220 of the welding device of the third embodiment has the eddy suppressing member 202a provided on the inner peripheral surface in the vicinity of the distal end portion of the shield nozzle 202. The eddy suppressing member 202a is constituted to include a plurality of projecting portions protruding toward a center axis A of the shield nozzle 202. This projecting portion may be a rod-shaped member or an annular member extending in a circumferential direction of the center axis A.

Since the eddy suppressing member 202a is provided on the inner peripheral surface in the vicinity of the distal end portion of the shield nozzle 202, an eddy generated in the shielding gas passing the vicinity of the eddy suppressing member 202a is crushed by the eddy suppressing member 202a. As a result, even if an eddy is generated by an influence of a shearing stress or the like generated between that and a wall surface of the shielding gas channel 204 in the shielding gas passing through the shielding gas channel 204, further growth of the eddy is suppressed.

Therefore, occurrence of the large-scale eddy structure in the shielding gas is suppressed, and the high-quality clad welding using the laser can be performed.

The present invention is not limited to the aforementioned embodiments but can be put into practice with modifications or changes as appropriate and as necessary within a scope not departing from a technical idea of the present invention.

### REFERENCE SIGNS LIST

100 welding device
200, 210, 220 nozzle part
201 powder nozzle
201a distal end portion
201b outer peripheral surface
201c taper portion
201d inner peripheral surface
202 shield nozzle
202a eddy suppressing member
203 powder gas channel
203a powder gas outlet
204 shielding gas channel
204a shielding gas outlet
300 laser part
301 laser beam
400 base material (welding target)
A center axis
B laser beam axis
P laser beam irradiation position

1. A welding device comprising:
a cylindrical powder nozzle that supplies a powder gas containing a powder welding material to a laser beam irradiation position of a welding target; and
a cylindrical shield nozzle that is arranged coaxially so as to cover an outer peripheral surface of the powder nozzle and supplies a shielding gas for isolating the laser beam irradiation position, wherein
the outer peripheral surface in the vicinity of a distal end portion of the powder nozzle has a shape whose outer diameter gradually decreases toward the distal end portion of the powder nozzle and has an arc shape on a section passing through a center axis of the powder nozzle.

2. The welding device according to claim 1, wherein
an inner peripheral surface in the vicinity of the distal end portion of the powder nozzle has a shape whose inner diameter gradually increases toward the distal end portion of the powder nozzle and has an arc shape on the section passing through the center axis of the powder nozzle.

3. A welding device comprising:
a cylindrical powder nozzle that supplies a powder gas containing a powder welding material to a laser beam irradiation position of a welding target; and
a cylindrical shield nozzle that is arranged coaxially so as to cover an outer peripheral surface of the powder nozzle and supplies a shielding gas for isolating the laser beam irradiation position, wherein
an eddy suppressing member that suppresses occurrence of an eddy by the shielding gas is provided on an inner peripheral surface in the vicinity of a distal end portion of the shield nozzle.

4. The welding device according to claim 3, wherein
the eddy suppressing member includes a plurality of projecting portions that protrude toward the center axis of the shield nozzle.

5. A welding method including a welding step in which a powder gas containing a powder welding material is supplied to a joining portion between a body portion of a turbine blade front edge portion and an erosion-resistant metal material and the body portion and the erosion-resistant metal material are clad welded by using the welding device according to claim 1.

6. A turbine blade in which an erosion-resistant metal material is clad welded by the welding method according to claim 5.
